(19) United States
(12) Patent Application Publication
(10) Pub. No.: US 2012/0212282 A1
(43) Pub. Date: Aug. 23, 2012

(54) METHODS, CIRCUITS AND SYSTEMS FOR MODULATING SUPPLY VOLTAGE TO A POWER AMPLIFIER

(75) Inventor: Solon Jose Spiegel, Ramat Aviv (IL)

(73) Assignee: RIO SYSTEMS LTD, Givat Shmuel (IL)

(21) Appl. No.: 13/031,223

(22) Filed: Feb. 20, 2011

(51) Int. Cl. G06G 7/12

(52) U.S. Cl. 327/355

(57) ABSTRACT

Disclosed are methods, circuits and systems for modulating supply voltage to a power amplifier. An input voltage signal may be received and used to drive a switching regulator (or the like), which regulator may be adapted to modulate (convert) battery supply voltage into a supply voltage of an amplifier. An output signal combining stage may include a signal combiner which may be adapted to combine a modulated battery supply voltage (i.e. modulated by the input voltage) with a residual error correction signal (RECS). The residual error correction signal may be based on an estimate of the switching regulator characteristics. The estimate may be at least partially based on feedback from an output of the regulator. The estimate may be at least partially based on a prediction model of the switch regulator.

### FIELD OF THE INVENTION

Some embodiments relate generally to the field of voltage regulators and power circuits and, more particularly, to methods, circuits and systems for modulating supply voltage to a power amplifier.

### BACKGROUND

Electronic circuits, ranging from simple operational amplifier circuits to large processor-driven systems, require a direct current (DC) input voltage. Whether the DC input voltage is in the range of microvolts or megavolts, it has to be stable for reliable circuit performance. For stable DC input voltage, the voltage level must remain at a constant level with minimal noise and with minimal alternating current (AC) ripple voltage.

Wireless communication has rapidly evolved over the past decades. Even today, when high performance and high bandwidth wireless communication equipment is made available there is demand for even higher performance at higher data rates, which may be required by more demanding applications. Modern Radio frequency (RF) communication systems demand complex modulation and coding schemes (e.g. CDMA, QPSK, QAM, QPSK/OFDM, QAM/OFDM, etc.) for increased bandwidth efficiency (e.g. greater than 1 bps/Hz for high data rate broadband communication systems).

Wireless communication circuits and systems rely on RF power amplifier circuits to provide the signal amplification needed to transmit a plurality of RF signals over varying distances and with varying signal strength. To change signal strength and maintain power efficiency at optimum levels, the supply voltage being delivered to the amplifier must be adjusted. In many modern wireless communication devices (e.g. mobile phones, smart phones, tablet computers, laptop computers, etc.), a single RF amplifier may process the varying signals being transmitted and received by the device (e.g. WIFI, Edge, CDMA, GPRS, UMTS, HSPA, WiMAX, etc. . . . ). In power efficient transmission architectures, the supply voltage should vary according to the envelope of the applied signal during envelope tracking, envelope elimination and envelope restoration. Since each signal type requires a specific amplification, the supply voltage delivered to the amplifier must follow the changes in the envelope of each signal type.

Traditional supply voltage regulators for RF power circuits use a negative feedback control loop to compare the output voltage with some stable voltage reference. While negative feedback is satisfactory for slower switching regulators, modern high speed switching regulators demand a faster predictive method for accurately modulating the supply voltage.

There is thus a need in the field of voltage regulators and power circuits for improved methods, circuits and systems for modulating supply voltage to a power amplifier.

### SUMMARY OF THE INVENTION

The present invention includes methods, circuits and systems for modulating supply voltage to a power amplifier. According to some embodiments, a residual error introduced by a switching regulator [between an envelope of the input signal and an output stages supply voltage signal,] may be mitigated by a feed-forward residual error correction signal. The correction signal may be provided by an adaptive digital filter with a self-adjusting transfer function and a closed loop system. The error correction signal may be used to subtract some or all of the residual error introduced into the power amplifier supply voltage using a voltage combiner (e.g. including mutually coupled inductors).

According to some embodiments of the present invention, there may be a supply voltage regulator for output power stages comprising a switching regulator, a residual error correction signal generator (RECSG) and a voltage combiner. The switching regulator may be adapted to convert an input supply voltage into an amplifier supply voltage. The RECSG may be adapted to generate a signal corresponding to an estimated waveform of an output of the switching regulator. The voltage combiner may be adapted to combine a signal generated by the RECSG with an output of the switching regulator. The voltage combiner may include mutually coupled inductors.

According to further embodiments of the present invention, the supply voltage regulator may further comprise a dynamic (i.e. adjustable) negative feedback loop.

According to some embodiments of the present invention, the RECSG may include a filter with a transform function corresponding to a transform function of the switching regulator. The filter may be a digital filter or an analog filter.

According to further embodiments of the present invention, the RECSG may include an adaptive filter. The adaptive filter may be a least mean squares (LMS) filter, a recursive least squares (RLS) filter, or any other suitable adaptive filter.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a prior art figure of a supply voltage modulator;

FIG. 2 is a functional block diagram of an exemplary radio frequency (RF) transmission chain including a supply voltage modulator according to some embodiments of the present invention;

FIG. 3 is a flow chart including the steps of a method by which a data signal may be converted and amplified according to some embodiments of the present invention;

FIG. 4A is an illustration of a zoom in to a signal converter according to some embodiments of the present invention;

FIG. 4B is an illustration of a zoom in to a supply voltage modulator according to some embodiments of the present invention;

FIG. 4C is an illustration of a zoom in to an amplitude modulation (AM) modulator according to some embodiments of the present invention; and

FIG. 4D is an illustration of a zoom in to an analog version of an amplitude modulation (AM) modulator according to some embodiments of the present invention;

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

It should be understood that some embodiments may be used in a variety of applications. Although embodiments of the invention are not limited in this respect, one or more of the methods, devices and/or systems disclosed herein may be used in many applications, e.g., civil applications, military applications, medical applications, commercial applications, or any other suitable application. In some demonstrative embodiments the methods, devices and/or systems disclosed herein may be used in the field of consumer electronics, for example, as part of any suitable television, video Accessories, Digital-Versatile-Disc (DVD), multimedia projectors, Audio and/or Video (A/V) receivers/transmitters, gaming consoles, video cameras, video recorders, portable media players, cell phones, mobile devices, and/or automobile A/V accessories. In some demonstrative embodiments the methods, devices and/or systems disclosed herein may be used in the field of Personal Computers (PC), for example, as part of any suitable desktop PC, notebook PC, monitor, and/or PC accessories.

According to some embodiments of the present invention, an input voltage signal is received and used to drive a switching regulator or an equivalent circuit or system. The regulator may be adapted to modulate (convert) battery supply voltage into a supply voltage of an amplifier. An output signal combining stage may include a signal combiner which is adapted to combine a modulated battery supply voltage (i.e. modulated by the input voltage) with a residual error correction signal (RECS). The signal combiner may contain a voltage combiner using mutually coupled inductors designed to increase the supply voltage for the power amplifier in proportion to an increase in the RECS. The signal combiner may contain a voltage combiner using transformers designed to switch between output voltage levels based on the RECS.

According to further embodiments of the present invention, the residual error correction signal may be based on an estimate of the switching regulator characteristics. The estimate may be at least partially based on feedback from an output of the regulator. The estimate may be at least partially based on a prediction model of the switch regulator.

According to some embodiments of the present invention, there may include a RECS generator (RECSG) functioning as a feed-forward error correction device/apparatus for supply voltage modulation. The RECSG may be integral to or functionally associated with the switching regulator and may be positioned on the same microelectronic chip and/or circuit.

According to some embodiments of the present invention, the RECSG may be a filter with a transform function corresponding to a transform function of the switching regulator. The RECS filter may be a digital filter or an analog filter. The RECS filter may be a least mean square (LMS) filter, a recursive least squares (RLS) or some other adaptive filter designed to adjust the transfer function of the filter according to an estimate of the transfer function of the switching regulator.

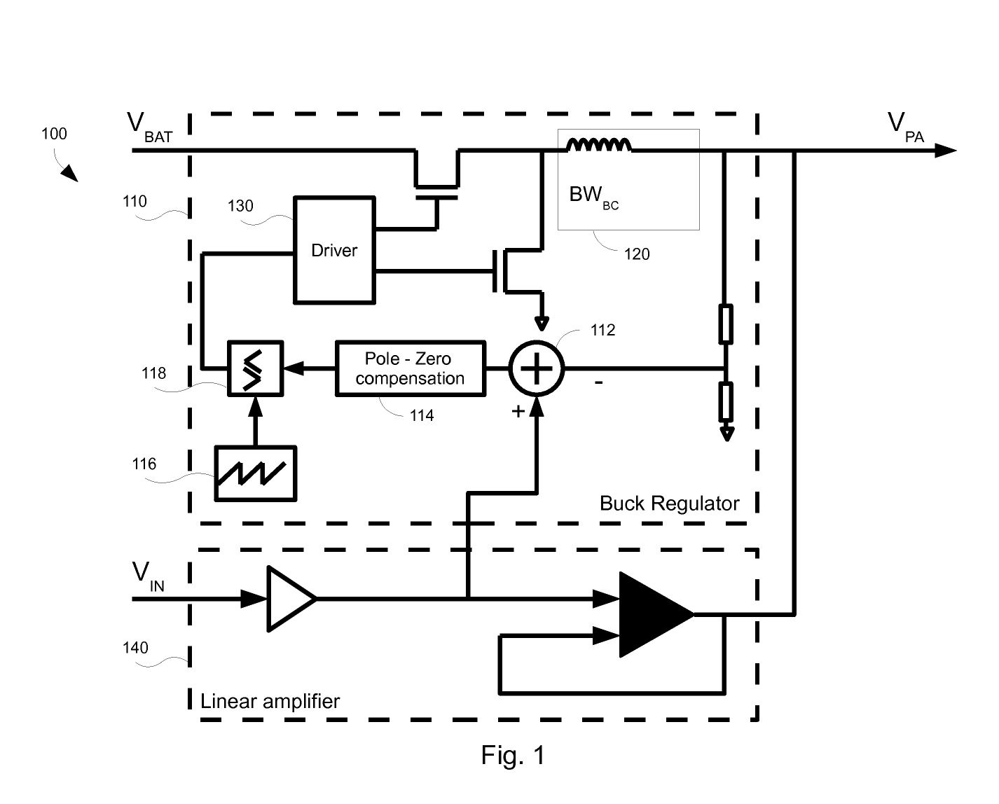

Now turning to FIG. 1, there is shown a prior art figure of a supply voltage modulator (100). A supply voltage modulator may include a voltage regulator (e.g. Buck regulator 110) to convert a battery voltage into a supply voltage (e.g. power amplifier input voltage—V_{PA}) based on some input signal. A supply voltage modulator may include a linear amplifier (140) to match the output supply voltage and increase the bandwidth of the signal by providing higher frequency components to the output signal.

Buck regulator 110 may include a driver (e.g. MOSFET gate driver 130) to bias a functionally associated pair of power switches (e.g. MOSFET transistors) to create an energy source for inductor 120. Inductor 120 may generate supply voltage V_{PA} corresponding to the applied current. A feedback loop may be combined (112) with the input signal and may undergo frequency compensation (e.g. Pole-Zero compensation 114) to improve stability of the signal. This signal may be compared by a high speed comparator (118) with a high frequency reference waveform (e.g. generated by Sawtooth waveform generator 116), thereby generating a pulse-width modulated (PWM) signal with a duty cycle directly proportional to the input signal. The resulting PWM signal may be used as the control signal for driver 130.

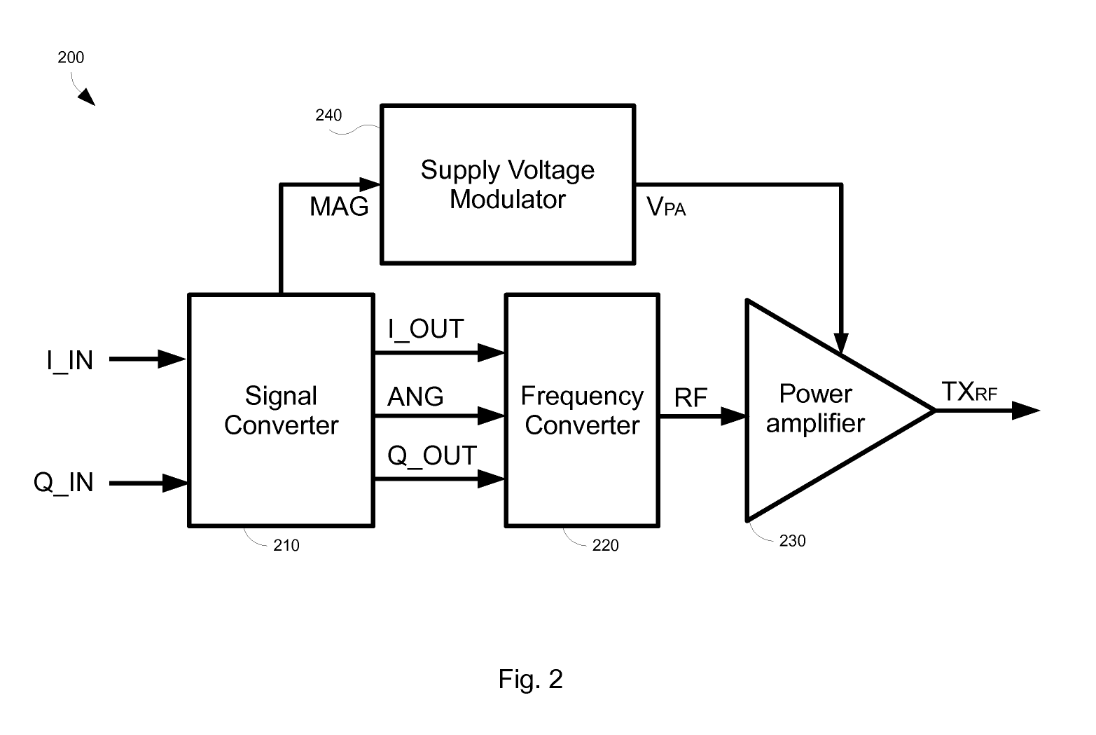

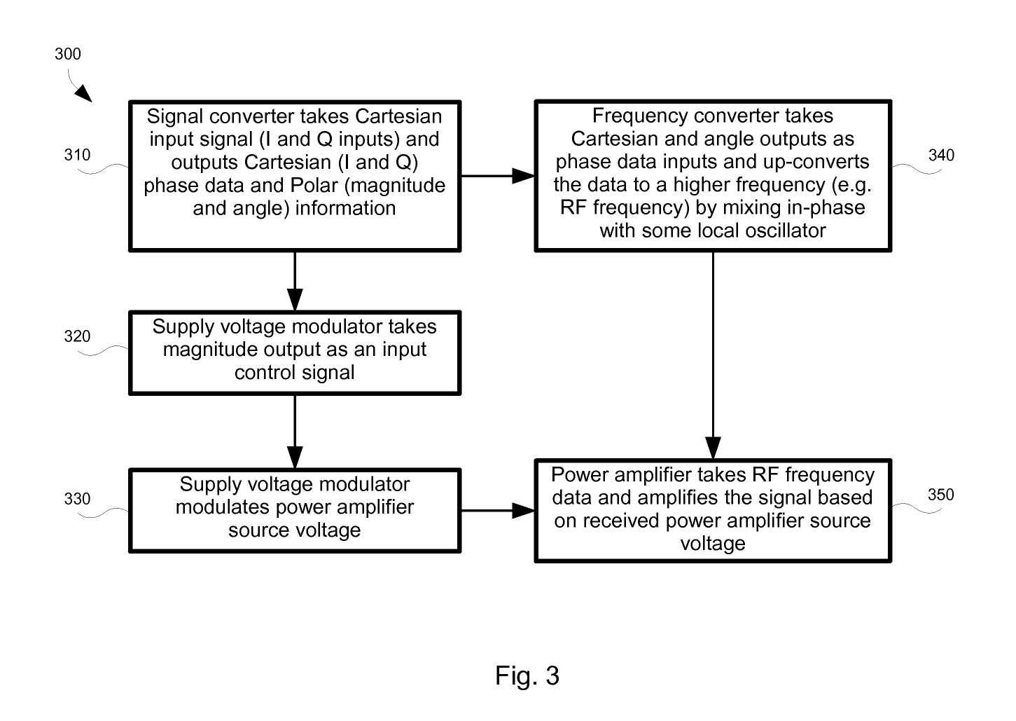

Now turning to FIG. 2, there is shown a functional block diagram of an exemplary radio frequency (RF) transmission chain (200) including a supply voltage modulator (240) according to some embodiments of the present invention. The transmission chain may be described in view of FIG. 3 showing a flow chart (300) including the steps of a method by which a data signal may be converted and amplified according to some embodiments of the present invention.

According to some embodiments of the present invention, RF transmission chain 200 may include signal converter 210. Signal converter 210 may take (310) a Cartesian input signal (I and Q inputs) and output Cartesian (I and Q) and/or polar (i.e. magnitude and angle) coordinate output values. A magnitude output from signal converter 210 may be used by supply voltage modulator 240 as an input control signal (320) and may modulate (330) a power amplifier source voltage output.

According to some embodiments of the present invention, RF transmission chain 200 may include frequency converter 220 and power amplifier 230. Frequency converter 220 may take (340) Cartesian and angle outputs from signal converter 210 as phase data inputs and may up-convert the data to a higher (e.g. RF transmission) frequency by mixing in-phase with some local oscillator. Power amplifier 230 may take (350) the up-converted data signal and amplify the signal based on received power amplifier source voltage from supply voltage modulator 240.

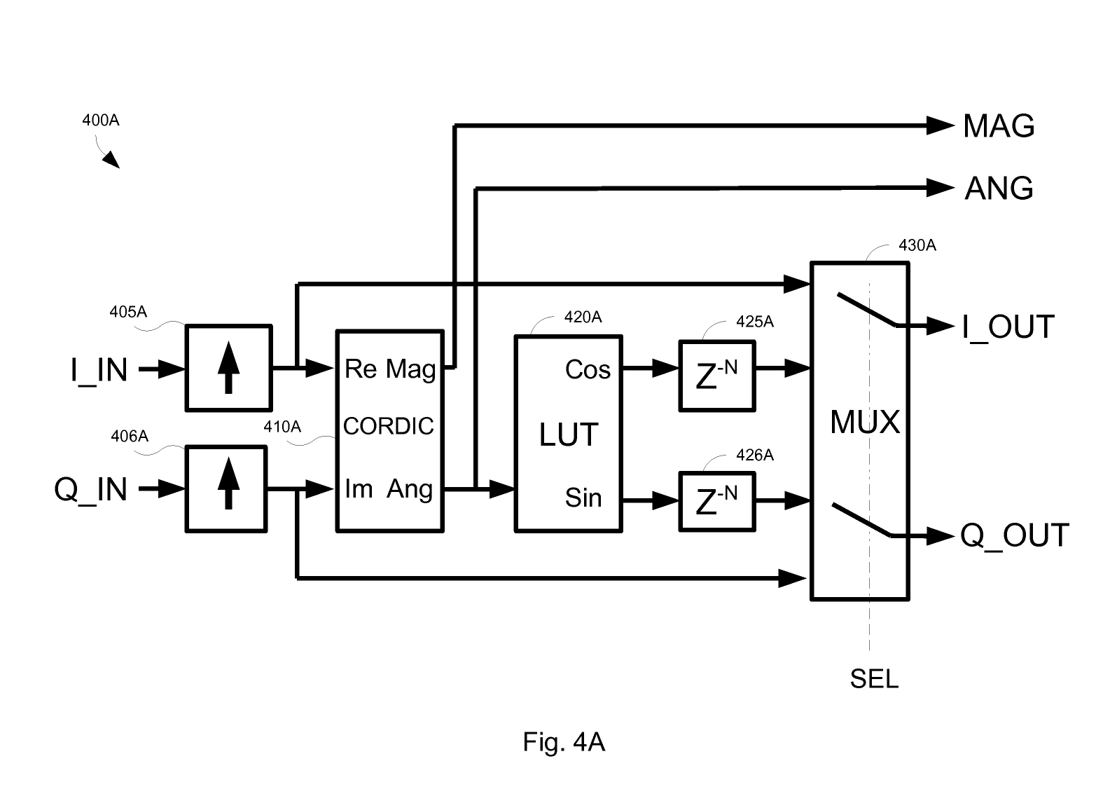

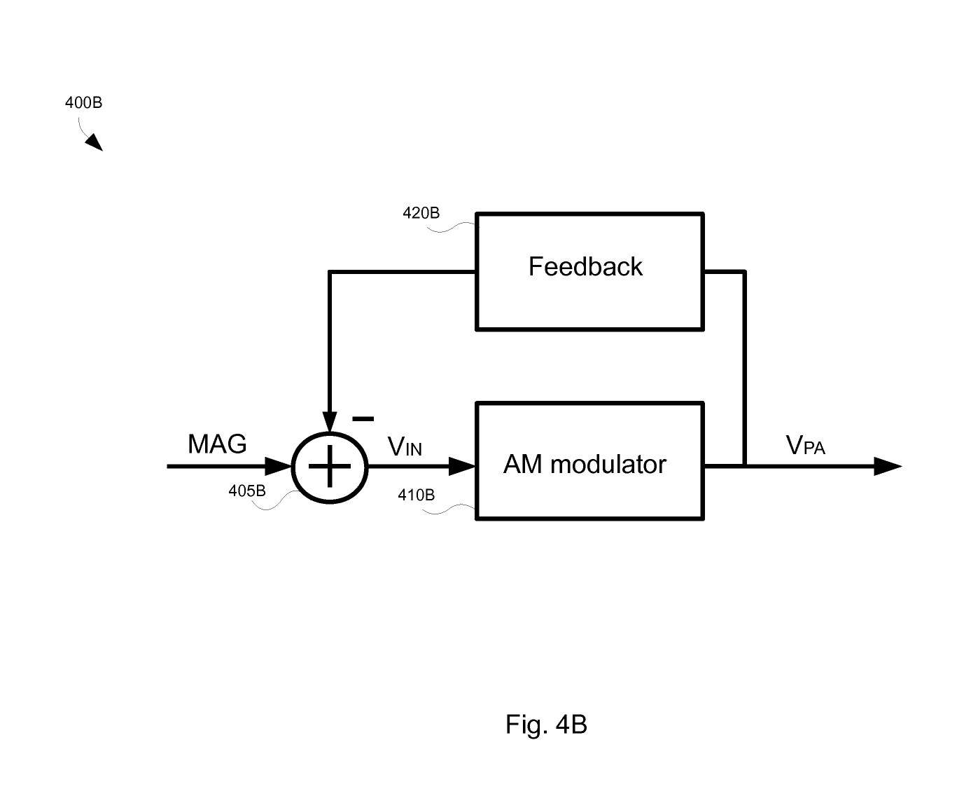

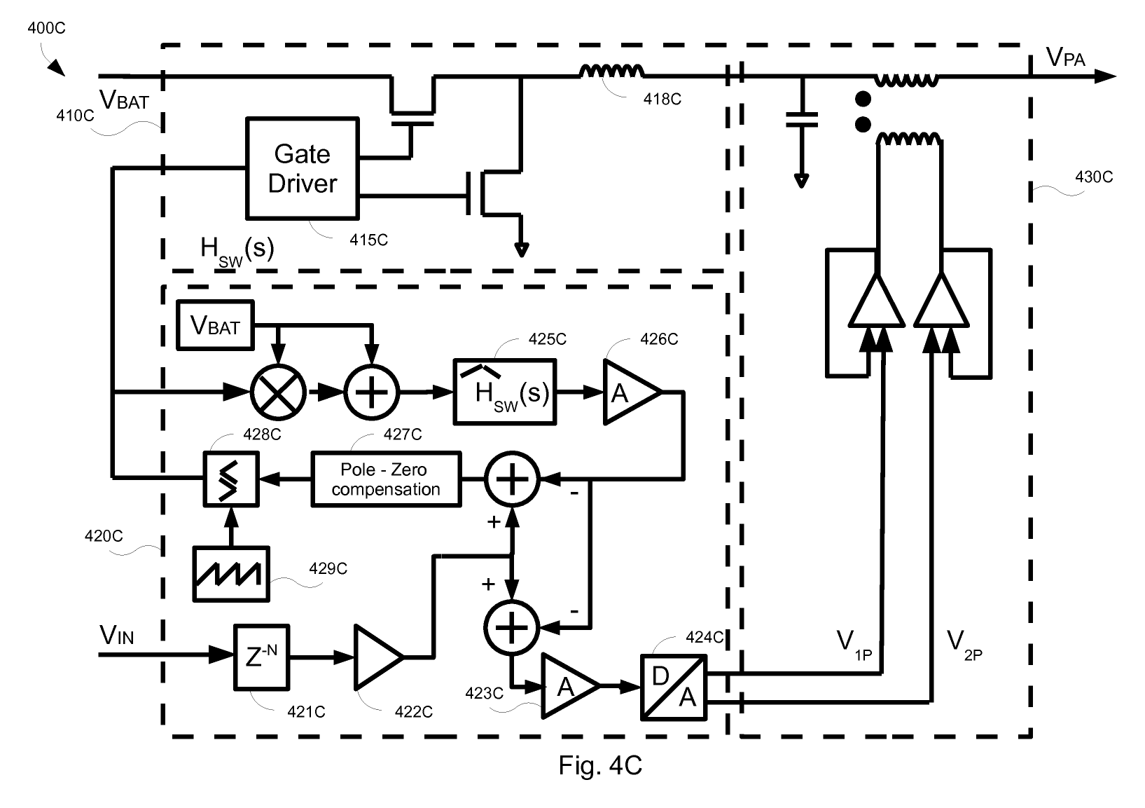

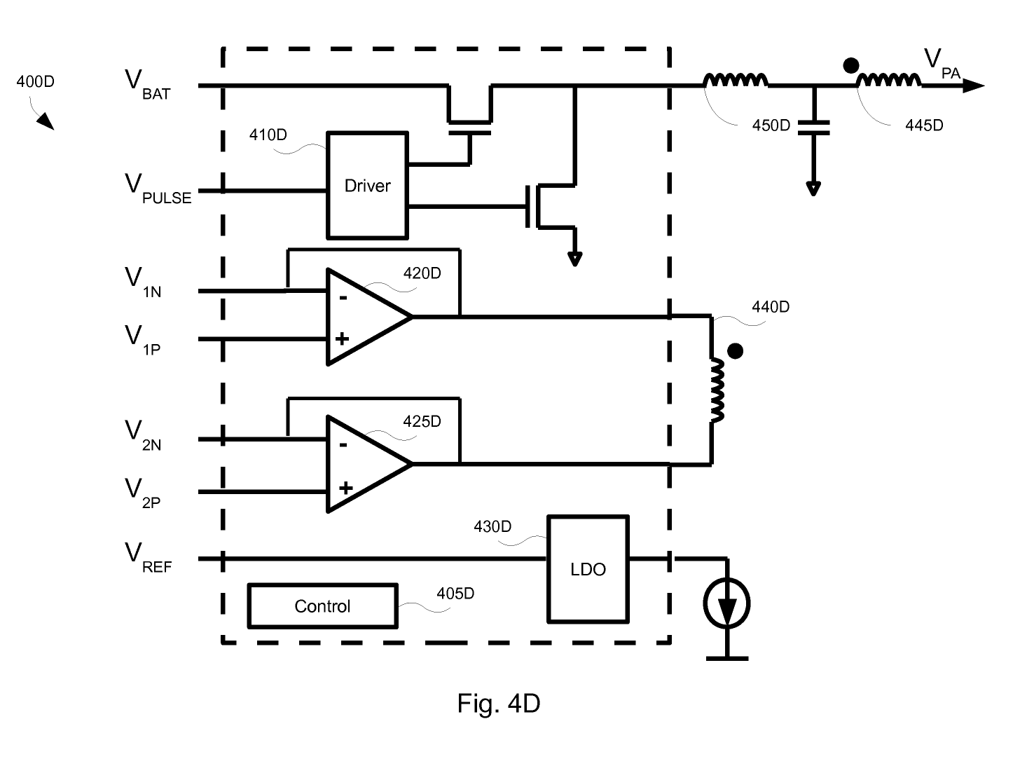

Now turning to FIG. 4A, there is shown an illustration of a zoom in to a signal converter (400A) according to some embodiments of the present invention. Cartesian coordinate (I and Q) inputs may be up-converted by up-converters 405A and 406A respectively. A functionally associated Coordinate rotation digital computer (CORDIC) block (410A) may take up-converted data and convert them from real and imaginary components of a data signal point into magnitude and angle (Polar) components of the data signal point. An angle component value may be used by a functionally associated look-up table (LUT 420A) to convert the value into cosine/sine phase data. The cosine/sine phase data may be delayed by delay lines 425A and 426A respectively to synchronize the phase data with its associated magnitude data. Signal converter 400A may further comprise a multiplexer (e.g. MUX 430A) to selectively output up-converted Cartesian inputs in addition to cosine/sine phase data.

Now turning to FIG. 4B, there is shown an illustration of a zoom in to a supply voltage modulator (400B) according to some embodiments of the present invention.

According to some embodiments of the present invention, supply voltage modulator 400B may contain an amplitude modulation (AM) modulator (410B). AM modulator 410B may be adapted to provide a switchable voltage source (V_{PA}) for a power amplifier based on a magnitude input (405B), output from a functionally associated signal converter. AM modulator 410B may contain a RECSG adapted to generate a forward residual error, i.e. error estimation signal based on an error function of the switchable voltage source. A dynamic (i.e. adjustable) feedback loop (420B) may be activated when a predicted error estimation signal is inaccurate (i.e. due to errors, adverse conditions, etc. . . . ). When there is a close enough prediction, dynamic feedback loop 420B may be deactivated.

Now turning to FIG. 4C there is shown an illustration of a zoom in to an amplitude modulation (AM) modulator (400C) according to some embodiments of the present invention. AM modulator 400C may comprise power block 410C, input and estimation block 420C and output block 430C.

According to some embodiments of the present invention, power block 410C provides a switchable voltage source to convert an input battery voltage (V_{BAT}) into a supply voltage for a power amplifier based on an input signal from input and estimation block 420C. Power block 410C may include a driver (e.g. MOSFET gate driver 415C) to bias a functionally associated pair of power switches (e.g. MOSFET transistors) to create an energy source for inductor 418C. Inductor 418C may generate an output voltage corresponding to the applied current.

According to some embodiments of the present invention, input and estimation block 420C may be input with an input signal V. The input signal may be sent through a delay line (421C) and may be amplified (e.g. by amplifier 422C). The amplified input signal may undergo frequency compensation (e.g. Pole-Zero compensation 427C) to improve stability of the signal. This signal may be compared by a high speed comparator (428C) with a high frequency reference waveform (e.g. generated by Sawtooth waveform generator 429C), thereby generating a pulse-width modulated (PWM) signal with a duty cycle directly proportional to the input signal. The resulting PWM signal may be used as the control signal for driver 415C.

According to further embodiments of the present invention, the PWM signal output from comparator 428C may be mixed with the input battery voltage and input to adaptive filter 425C (e.g. a least mean squares (LMS) filter, a recursive least squares (RLS) filter, or any other suitable adaptive filter). Adaptive filter 425C may adjust its transfer function of the filter according to an estimate of the transfer function of power block 410C using the observable input PWM and V_{BAT} signals. An output signal from adaptive filter 425C may be a predictive residual error correction signal (RECS) and may be further amplified by amplifier 426C.

According to further embodiments of the present invention, the amplified RECS may be used as a feedback signal by subtracting the RECS signal from the input signal before frequency compensation 427C. By combining the input signal with the RECS, PWM signal noise generated by comparator 428C may be substantially attenuated.

According to further embodiments of the present invention, the amplified RECS may be combined with the amplified input signal and amplified (423C). The amplification may match amplifier 426C and may increase the peak-to-peak voltage of the signal to match V_{BAT}. Alternatively, the peak-to peak voltage of the RECS may be increased by varying the number of windings of functionally associated mutually coupled inductors. The resulting signal may be converted into substantially equivalent analog versions of the signal by digital-to-analog converter (DAC) 424C. The output signals from DAC 424C may be used to recover any attenuated high frequency components of the output signal from power block 410C.

According to some embodiments of the present invention, output block 430C may contain a pair of differential input operational amplifiers. The analog version of the RECS may be used by the operational amplifiers as a residual error differential input to a functionally associated inductor. The inductor may be mutually coupled with an output stage inductor to generate an output voltage, which is combined with the output voltage from power block 410C. The combination of the output voltages may be output from output block 430C as a supply voltage for a power amplifier (V_{PA}).

Now turning to FIG. 4D, there is shown an illustration of a zoom in to an analog version of an amplitude modulation (AM) modulator (400D) according to some embodiments of the present invention.

According to some embodiments of the present invention, AM modulator 400D provides a switchable voltage source to convert an input battery voltage (V_{BAT}) into a supply voltage for a power amplifier (V_{PA}) based on a V_{PULSE} externally applied input signal. AM modulator 400D may include a driver (e.g. MOSFET gate driver 410D) to bias a functionally associated pair of power switches (e.g. MOSFET transistors) to create an energy source for a functionally associated inductor (450D). Inductor 450D may generate an output voltage corresponding to the applied current.

According to further embodiments of the present invention, AM modulator 400D may include a pair of op-amps (420D and 425D) adapted as differential inputs to a coupled inductor (440D, mutually coupled with inductor 445D). The behavior of op-amps 420D and 425D may change based on externally applied voltages signals (i.e. V_{1P}—the positive input voltage signal of op-amp 420D, V_{1N}—the negative input voltage signal of op-amp 420D, V_{2P}—the positive input voltage signal of op-amp 425D and V_{2N}—the negative input voltage signal of op-amp 425D). Feedback loops for op-amps 420D and 425D may be applied externally to vary the gain of each amplifier respectively. Inductor 440D may generate an output voltage corresponding to an applied current from differential input op-amps 420D and 425D. The generated output voltage may induce a voltage on mutually coupled inductor 445D, which voltage may be added to the voltage generated by inductor 450D and output as power amplifier supply voltage V_{PA}.

According to some embodiments of the present invention, AM modulator 400D may include a low-dropout regulator (LDO—430D) to bias op-amps 420D and 425D to compensate for signal noise.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A supply voltage regulator for output power stages comprising:
a switching regulator adapted to convert an input supply voltage into an amplifier supply voltage;
a residual error correction signal generator (RECSG) adapted to generate a signal corresponding to an estimated waveform of an output of said switching regulator; and
a voltage combiner adapted to combine a signal generated by the RECSG with an output of said switching regulator.

2. The supply voltage regulator according to claim 1, further comprising a dynamic negative feedback loop.

3. The supply voltage regulator according to claim 1, wherein the RECSG includes a filter with a transform function corresponding to a transform function of said switching regulator.

4. The supply voltage regulator according to claim 3, wherein the filter is a digital filter.

5. The supply voltage regulator according to claim 3, wherein the filter is an analog filter.

6. The supply voltage regulator according to claim 3, wherein the RECSG includes an adaptive filter.

7. The supply voltage regulator according to claim 6, wherein the RECSG includes a least mean squares (LMS) filter.

8. The supply voltage regulator according to claim 6, wherein the RECSG includes a recursive least squares (RLS) filter.

9. The supply voltage regulator according to claim 1, wherein the voltage combiner includes mutually coupled inductors.

10. A method of supply voltage regulation for an output power stages comprising:
a switching regulating to convert an input supply voltage into an amplifier supply voltage;
deriving a residual error correction signal from an estimated waveform of an output produced by switch regulation; and
combining the residual error correction signal with the output produced by switch regulation.

11. The method according to claim 10, further comprising providing a dynamic negative feedback loop.

12. The method according to claim 10, wherein the RECSG includes a filter with a transform function corresponding to a transform function of said switching regulator.

13. The method according to claim 12, wherein the filter is a digital filter.

14. The supply voltage regulator according to claim 12, wherein the filter is an analog filter.

15. The method according to claim 12, wherein the RECSG includes an adaptive filter.

16. The supply voltage regulator according to claim 15, wherein the RECSG includes a least mean squares (LMS) filter.

17. The method according to claim 15, wherein the RECSG includes a recursive least squares (RLS) filter.

18. The method according to claim 10, wherein the voltage combiner includes mutually coupled inductors.
